(19) United States
(12) Patent Application Publication
(10) Pub. No.: US 2007/0272887 A1
(43) Pub. Date: Nov. 29, 2007

(54) Dual Bypass for Piston-Type Flushometer

(76) Inventors: Daniel J. Carroll, Hammond, IN (US); Paul A. Schmitt, Chicago, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/420,492

(22) Filed: May 26, 2006

(51) Int. Cl. F16K 31/12

(52) U.S. Cl. 251/40

(57) ABSTRACT

A flushometer for use with urinals or water closets includes a hollow valve body having an inlet, an outlet, and a valve seat therebetween. There is a piston or diaphragm movable in the hollow valve body to a closing position on the valve seat to control flow through the valve. A pressure chamber is above the piston or diaphragm for holding it on the valve seat. The piston or diaphragm includes a plurality of bypass orifices to connect the inlet with the pressure chamber to provide fluid to move the piston or diaphragm to the closing position.

### BACKGROUND OF THE INVENTION

This invention generally relates to a diaphragm or piston-type flushometer for use in a urinal, water closet, or the like. More particularly, the invention relates to a flushometer having a plurality of bypass orifices.

Piston-type flushometers having bypass orifices are well known, as exemplified by the flush valve shown in U.S. Pat. No. 4,261,545, which is hereby incorporated herein by reference. Diaphragm-type flushometers also have bypass orifices, as exemplified by the flush valve shown in U.S. Pat. No. 6,616,119, which is hereby incorporated herein by reference. The bypass orifice provides inlet fluid pressure above the piston or diaphragm for closing and then holding the piston assembly or diaphragm on the valve seat after the flush operation. The orifice is sized to allow a predetermined amount of fluid flow through the flush valve before the valve closes.

In order for the flush valve to work properly, the bypass orifice must remain unclogged and functional, otherwise insufficient fluid flow will be allowed into a pressure chamber above the piston assembly and the valve will not close as intended. One approach to this concern has been to provide a filter which prevents the small bypass orifice from clogging with particulates from the fluid inlet. One disadvantage of a filtered bypass orifice is that the filter can allow irregularly-shaped particulates to pass through which may later clog the downstream orifice. Another disadvantage is that the filter itself may become clogged with sediment, thereby preventing or significantly limiting flow through the bypass orifice. When the filter becomes clogged, the flush valve must be disassembled so the filter can be cleaned or replaced.

Yet another disadvantage of a piston according to the '545 patent is that the angular orientation of the piston affects the performance of the flush valve. For example, if the orifice is spaced 180° from the inlet connection, then the water must travel a greater distance than if the orifice is directly aligned with the inlet connection. A greater water travel distance requires a greater pressure for the piston to function and tends to increases the flush volume, both of which increase the operation costs. This dependence on angular orientation is not remedied by the provision of a filter.

As set forth in more detail below, the present invention provides an improved piston for use with a flush valve assembly.

### SUMMARY OF THE INVENTION

This invention provides a piston having a plurality of bypass orifices spaced apart from each other about the perimeter of the piston. In one embodiment, two identical bypass orifices are provided diametrically spaced from each other.

The provision of at least a second bypass orifice reduces the clogging risk associated with a single bypass orifice and a piston according to the present invention provides additional benefits. For example, the importance of the angular orientation of the piston is greatly reduced, because there is always a bypass orifice no more than 90° away from the inlet connection. This simplifies assembly of the valve, because the piston does not have to be installed in any particular alignment. Also, the upper pressure chamber is more consistently vented and the influence of fixture-induced back pressure in the valve is reduced, which permits a more accurate flush. Furthermore, water travel distance from the filter to a bypass orifice is reduced, which increases the consistency of flush volumes and allows the piston to function at relatively low pressures. The reduced travel distance also better enables the groove surrounding the outer surface of the piston to control flow into the bypass orifices.

In addition to these performance benefits, a multiple-orifice piston may be integrated into existing flush valve assemblies without modifying any other components of the valve assembly. In particular, the use of a piston with two bypass orifices allows for the flush valve assembly to provide a decreased flush volume with an existing relief valve. This is preferable to the alternative, i.e., providing a shorter relief valve, because it insures repeatable performance, especially at low pressure.

If further anti-clogging properties are desired, then a piston according to the present invention may be provided with a filter associated with one or all of the bypass orifices.

### BRIEF DESCRIPTION OF THE DRAWINGS

FIG. 1 is a vertical section through a flushometer illustrating the piston design of the present invention.

FIG. 2 is an enlarged side elevation view of the piston.

FIG. 3 is a section taken along line 3-3 of FIG. 2.

FIG. 4 is a bottom plan view of the piston of FIGS. 2 and 3.

### DETAILED DESCRIPTION OF THE INVENTION

The piston of the present invention is conventionally used with flushometer assemblies for urinals or water closets. The flushometer piston is designed to control the flow of water through the flushometer to provide a specific quantity of water for each flushing operation, with the water passing through the flushometer at a high flow rate even when the water pressure is on the low side of the range of water pressures commonly found in the United States. Although the invention will be described in which the desired volume per flush is 1.6 gallons or six liters, it should be understood that the size of the various parts may be modified to provide different volumes of water per flush.

The flushometer as shown has a generally hollow valve body 10 which includes an inlet connection 12, an outlet connection 14, and a handle coupling connection 16. The top of the valve body is closed by a cover 18 and there may be a seal element 19 between the cover and the body. A main valve seat 20 is formed on the interior walls of the body 10. The valve is actuated by an operating handle 22 which is fastened to the valve body 10 by means of a coupling nut 24. The handle is connected to a plunger 26 which extends to the interior portion of the valve body. The plunger 26 is guided and supported by a bushing 28 and is restored by a spring 30. A rubber sealing cap or packing 32 is snapped on the end of bushing 28 and prevents leakage outwardly from the handle opening. The valve as shown has a manual handle 22 for operation. The valve is equally adaptable to automatic operation, for example by a solenoid.

A piston assembly indicated generally at 34 is adapted to reciprocate within the body 10. The piston assembly 34 includes a hollow, generally cylindrical piston 36. The piston 36 has a lower cylindrical extension 38 which is directly adjacent a piston seat area 39, with the seat area 39 being normally seated upon a seal member 41 to close the main valve seat 20 and to thereby control the flow of water through the flushometer.

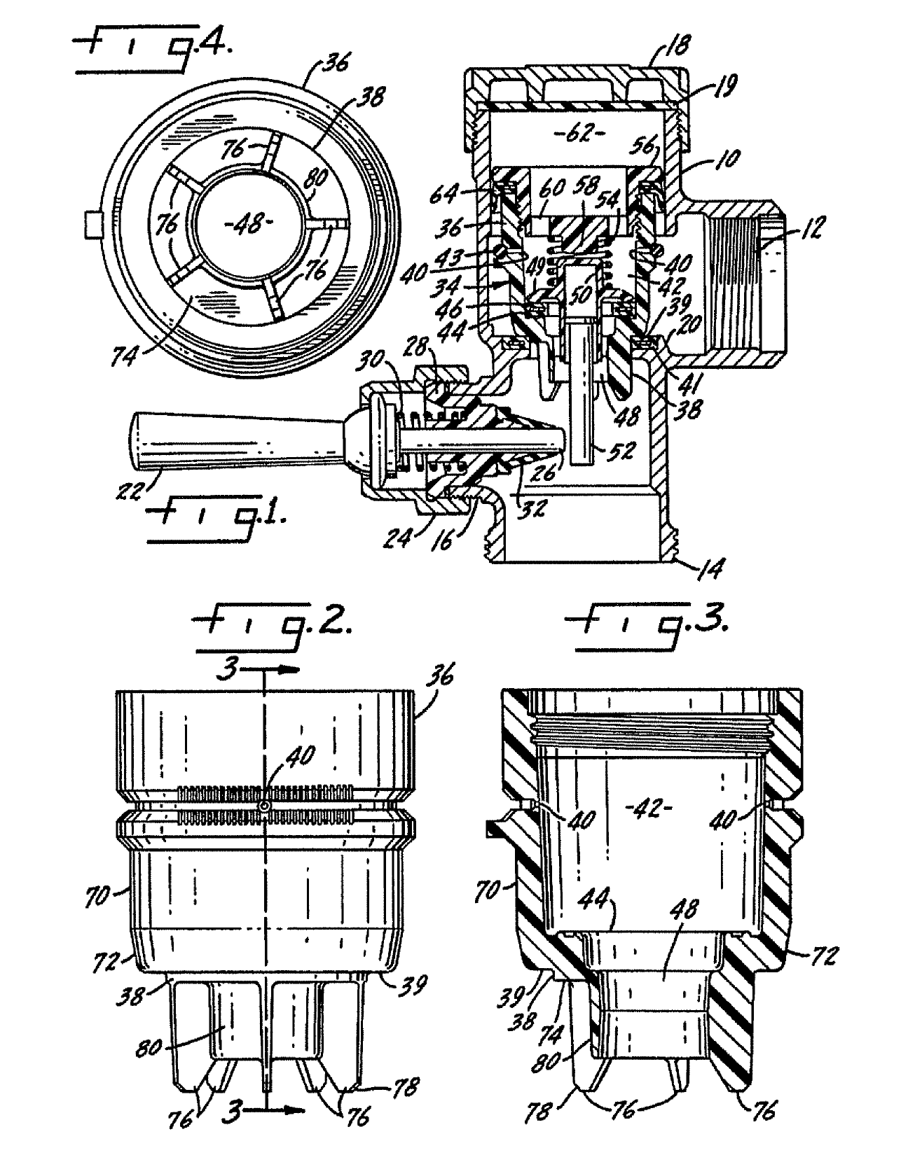

The piston 36 of FIG. 1 has a pair of bypass orifices 40, which are illustrated with an optional filter ring 43, which ring 43 functions according to known principles for providing additional anti-clogging properties. The bypass orifices are preferably diametrically opposed to each other and connect the inlet side of the flushometer with the interior chamber 42 of the piston. In a preferred embodiment, the orifices are identical and have a small diameter which may range in size from 0.020″ to as much as 0.0245″, with the size of the diameter controlling the rate at which chamber 42 fills to cause closure of the flushometer.

The interior chamber 42 of the piston 36 has an annular ledge 44 supporting a seal 46. The ledge and seal are at the top of a central passage 48 which connects chamber 42 with the outlet side of the flushometer.

The piston assembly 34 also includes a relief valve 50 which normally closes passage 48 of the piston 36. The relief valve has a collar 49 which engages the seal 46 on the annular ledge of the piston. An operating stem 52 is slidable in the central hollow portion of the relief valve 50 and extends to a point adjacent plunger 26. A spring 54 assists in holding the relief valve 50 in its position to close and seal chamber 42.

The piston assembly 34 further includes an insert 56 threadedly engaging the upper wall of piston 36. The insert 56 has a central stop 58 against which the spring 54 abuts. The stop has holes 60 which provide fluid communication between the piston interior chamber 42 and an upper pressure chamber 62. A packing member or seal member 64 held between the insert 56 and piston 36 provides a slidable seal separating the pressure chamber 62 from inlet water pressure.

The piston 36 has a cylindrical wall 70 which is preferably smooth and unobstructed. Directly adjacent the cylindrical wall 70 is a tapered piston area 72 which may have a taper of on the order of about ten degrees, which taper is effective to provide a clear flow path about the piston when it is in the raised position away from the valve seat 20. Directly adjacent the beveled area 72 is the piston seat area 39 which will close upon the seat 20 when the valve is in the closed position. Directly downstream of the piston seat area 39 is a ring 74 which has an outer diameter slightly less than the diameter of the valve outlet adjacent the seat 20 so that ring area 74 will be inside of the valve seat when the piston is closed. The ring 74 functions as a throttling means in that it substantially reduces flow through the valve outlet just prior to complete valve closure.

Directly adjacent the throttling ring 74 is piston portion 38 which has a plurality of radially and axially extending ribs 76. The outer diameter of the ribs is less than wall 70 and just slightly less than the passage through seat 20. The ribs are thus inside of the major portion of the piston so as not to restrict flow. In a preferred embodiment five ribs are provided for maximizing stability and guidance for the piston, without detrimentally obstructing water flow past the piston when the piston is in the valve open position. At the lower end of each of the axially extending ribs there is a chamfered area 78 which assists in assembling the piston within the flushometer assembly.

The area between each of the circumferentially, generally uniformly spaced ribs 76 is closed by a skirt 80. As shown, the skirt 80 has a radius slightly less than the exterior surface of the ribs 76. The function of the skirt is to close the area between ribs to provide control of water flow past the piston, which in turn will provide a more consistent operation of the flushometer. The skirt improves the flow path by maintaining it in an axial direction generally circumferentially about the piston portion 38. By preventing water flow into the water passage 48, the skirt also helps prevent any back pressure which might retard closure of the relief valve.

The skirt area 80 terminates short of the downstream end of each of the ribs 76. This helps prevents back pressure from being created downstream of the piston, which would in turn retard the closure of the piston. The longer the piston is held in an open position, the greater the water flow through the flushometer. Termination of the skirt short of the axial downstream end of the ribs reduces back pressure which might retard closure of the piston and the presence of the skirt reduces back pressure which would retard the closure of the relief valve. To the extent that there is any back pressure, the use of a multiple-orifice piston according to the present invention reduces the influence of any fixture-induced back pressure, which provides a more accurate flush.

In addition to reducing the influence of back pressure, a piston having multiple orifices provides other benefits. For example, in the angular orientation of FIG. 1, one of the bypass orifices 40 is directly aligned with the inlet connection 12, while the other is 180° away from the inlet connection 12. This orientation minimizes the water travel distance, because water from the inlet connection 12 can enter interior chamber 42 through the nearest orifice 40 and need not travel to the opposite side of the piston 34. As a result, the valve quickly closes after use, which reduces flush volume, and can be closed at a relatively low water pressure. In contrast, a piston having only one orifice located 180° away from the inlet connection results in an increased water travel distance, requiring a relatively higher water pressure to close the valve and resulting in greater flush volume. Even if the piston 34 rotates out of the orientation of FIG. 1, it can be seen that at least one of the orifices 40 will be no more than 90° away from the inlet connection 12. The present invention also increases the consistency of the piston and valve flush volume. The bypass orifices can be sized to allow a lower volume per flush without adding or subtracting any parts from the piston or from the filter mechanism. Further, the invention can function at lower pressures than pistons with standard bypass configurations.

It will be understood that the embodiments of the present invention which have been described are illustrative of some of the applications of the principles of the present invention. Numerous modifications may be made by those skilled in the art without departing from the true spirit and scope of the invention, including those combinations of features that are individually disclosed or claimed herein. For example, the bypass orifices may be separated by an angle other than 180° or additional bypass orifices may be provided and spaced about the piston at regular or differing angles. Or, the multiple orifice construction could be adapted for use with diaphragm-type flushometers, in addition to the piston-type flushometers illustrated in the drawings. For these reasons, the scope of the invention is not limited to the above description but is as set forth in the following claims.

We claim:

1. A flushometer assembly for a urinal or water closet having a hollow valve body with an inlet, an outlet and a valve seat between the inlet and the outlet, a piston movable in the hollow valve body to a closing position on the valve seat to control fluid flow between the inlet and the outlet, a pressure chamber above the piston for holding the piston on the valve seat, the piston including a plurality of bypass orifices passing therethrough to fluidly connect the inlet with the pressure chamber to provide fluid to move the piston to the closing position.

2. The flushometer assembly of claim 1 wherein the plurality of bypass orifices comprises two bypass orifices.

3. The flushometer assembly of claim 2 wherein the two bypass orifices are diametrically spaced from each other.

4. The flushometer assembly of claim 1 wherein each bypass orifices is equally spaced from adjacent bypass orifices.

5. The flushometer assembly of claim 1 wherein the bypass orifices are identical to one another.

6. The flushometer assembly of claim 1 further comprising a filter associated with at least one of the bypass orifices.

7. The flushometer assembly of claim 1 further comprising a filter associated with all of the bypass orifices.

8. In flushometer of the type having a hollow valve body with an inlet, an outlet and a valve seat between the inlet and the outlet, a piston movable in the hollow valve body to a closing position on the valve seat to control fluid flow between the inlet and the outlet, and a pressure chamber above the piston for holding the piston on the valve seat, the improvement comprising a piston having a plurality of bypass orifices passing through the piston to fluidly connect the inlet with the pressure chamber to provide fluid to move the piston to the closing position.

9. The piston of claim 8 wherein the plurality of bypass orifices comprises two bypass orifices.

10. The piston of claim 9 wherein the two bypass orifices are diametrically spaced from each other.

11. The piston of claim 8 wherein each bypass orifices is equally spaced from adjacent bypass orifices.

12. The piston of claim 8 wherein the bypass orifices are identical to one another.

13. The piston of claim 8 further comprising a filter associated with at least one of the bypass orifices.

14. The piston of claim 8 further comprising a filter associated with all of the bypass orifices.

15. A flushometer assembly for a urinal or water closet having a hollow valve body with an inlet, an outlet and a valve seat between the inlet and the outlet, a control member movable in the hollow valve body to a closing position on the valve seat to control fluid flow between the inlet and the outlet, a pressure chamber above the control member for holding the control member on the valve seat, the control member including a plurality of bypass orifices passing therethrough to fluidly connect the inlet with the pressure chamber to provide fluid to move the control member to the closing position.

16. The flushometer assembly of claim 15 wherein the plurality of bypass orifices comprises two bypass orifices.

17. The flushometer assembly of claim 16 wherein the two bypass orifices are diametrically spaced from each other.

18. The flushometer assembly of claim 15 wherein each bypass orifices is equally spaced from adjacent bypass orifices.

19. The flushometer assembly of claim 15 wherein the bypass orifices are identical to one another.

20. The flushometer assembly of claim 15 further comprising a filter associated with at least one of the bypass orifices.

21. The flushometer assembly of claim 15 further comprising a filter associated with all of the bypass orifices.
